(19) United States
(12) Patent Application Publication
(10) Pub. No.: US 2014/0356048 A1
(43) Pub. Date: Dec. 4, 2014

(54) UNIVERSAL CONNECTOR

(71) Applicant: Yu-Hung CHOU, Taichung City (TW)

(72) Inventor: Yu-Hung CHOU, Taichung City (TW)

(21) Appl. No.: 13/909,350

(22) Filed: Jun. 4, 2013

(51) Int. Cl. F16C 11/10

(52) U.S. Cl. CPC F16C 11/103
USPC 403/57

(57) ABSTRACT

The universal connector includes a main rod defining an axial direction, a main body, a positioning member, and a fastening member. The main body has a first through hole, two arms, and a second through hole penetrating through the arms. The main body is sleeved onto the main rod by the first through hole. The positioning member and the fastening member are disposed at two ends of the second through hole respectively. The positioning member forms an aperture for receiving a support of a musical instrument. Angle of the support can be adjusted by rotating the positioning member, and height or direction of the support can be adjusted by moving or rotating the main body. When the positioning member and the fastening member are engaged with each other to fasten the main body and the main rod together, the support is prevented from moving.

### BACKGROUND OF THE INVENTION

1. Field of the Invention

The present invention relates to a universal connector, more specifically to a universal connector for music instruments.

2. Description of the Prior Art

A conventional universal connector, as disclosed in patent TW M367394, has a first adjustment structure and a second adjustment structure for adjusting direction or angle of a support of a musical instrument. However, the structure is too complicated and includes too many components and is difficult to install. Also, the first adjustment structure and the second adjustment structure have to be adjusted respectively for adjusting angle or angle of the support.

Another universal connector disclosed in patent TW M337731 includes a main body comprising a base, a fixation member, and a fastening member. The main body further includes a supporting rod, a rotating axle, and a locking structure. The locking structure is adapted for fastening the fixation member and the fastening member together to further fasten the rotating axle and the supporting rod. The rotating axle is adapted for a connecting rod of a musical instrument to insert through. However, the structure only allows adjustment of angle but not height or direction.

### SUMMARY OF THE INVENTION

The main object of the present invention is to provide a universal connector adapted for alternating angle, direction, and position of a support of a music instrument.

To achieve the above and other objects, a universal connector of the present invention includes a main rod, a main body, a positioning member, and a fastening member.

The main rod defines an axial direction. The main body has a first through hole and two arms. The first through hole is adapted for the main body to be sleeved on the main rod. The main body is rotatable with respect to the main rod around the axial direction and is also movable with respect to the main rod along the axial direction. The main body further has a second through hole penetrating both the two arms. Extending directions of the first through hole and the second through hole are not parallel to each other. A breach is defined between the two arms. The breach crosses the second through hole and communicates with the first through hole. The fastening member and the positioning member are rotatably disposed at two sides of the second through hole respectively. The positioning member has an aperture for a support of a musical instrument to insert through. The positioning member is alternatively engaged with the fastening member. When the positioning member is engaged with the fastening member to narrow the breach, the main body and the main rod are fastened together, and the support abuts against an outer surface of the main body and is positioned in the aperture of the positioning member.

Thereby, angle of the support with respect to the main body can be adjusted by rotating the positioning member with respect to the main rod, and direction or position of the support can be adjusted by moving or rotating the main body with respect to the main rod along the axial direction. Thus, the present invention facilitates adjustment of the support and is able to position the support easily.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of the present invention;

FIGS. 2 and 3 are illustrations of the present invention;

FIG. 4 is a profile of the present invention when a positioning member and a fastening member are not engaged tightly with each other;

FIG. 5 is a profile of the present invention when a positioning member and a fastening member are engaged tightly with each other.

### DETAILED DESCRIPTION OF THE PREFERRED EMBODIMENTS

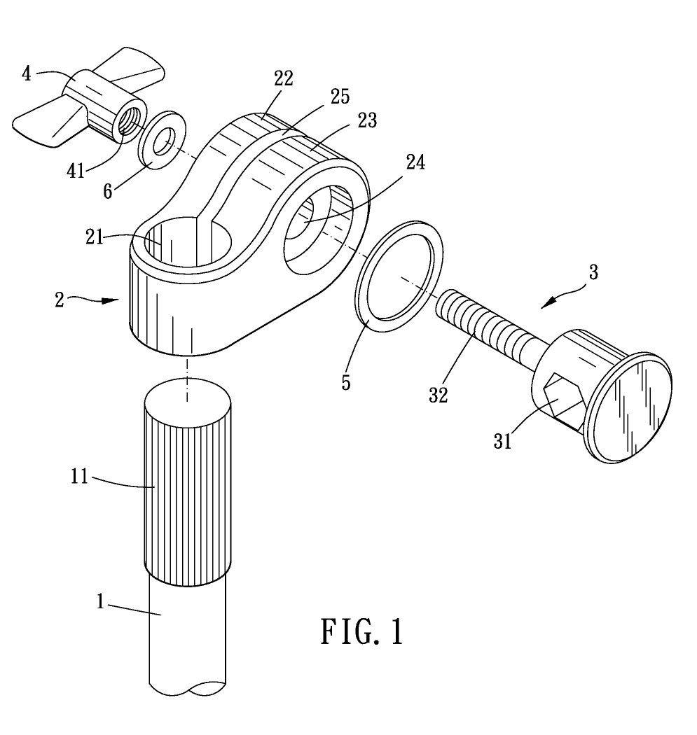

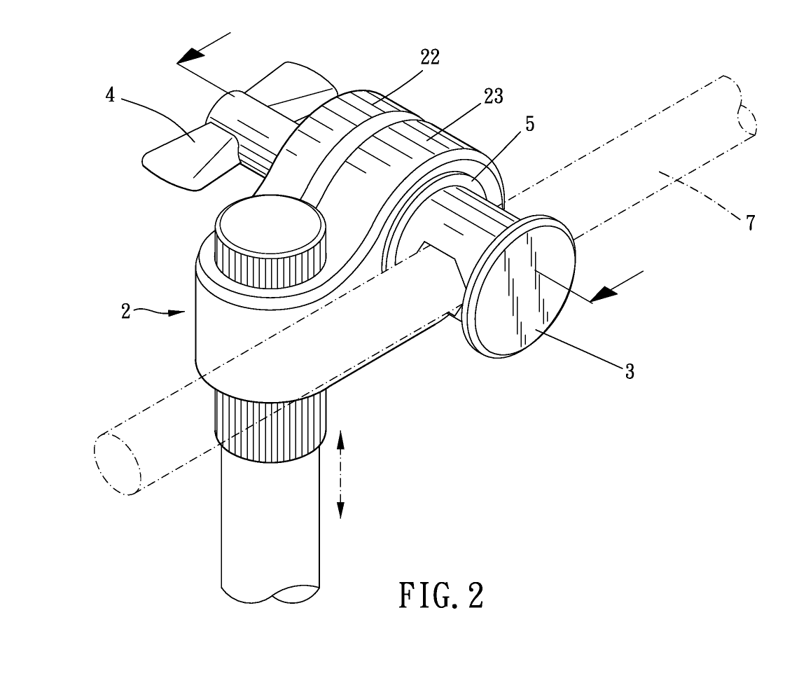

Please refer to FIG. 1 to FIG. 3, the universal connector of the present invention includes main rod 1, a main body 2, a positioning member 3, and a fastening member 4.

The main rod 1 defines an axial direction. More specifically, the axial direction is parallel to a longitudinal direction of the main rod 1. In the preferred embodiment, the main rod 1 is formed with knurling 11 on an outer surface thereof.

The main body 2 has a first through hole 21 and two arms 22, 23. The first through hole 21 is adapted for the main body 2 to be sleeved onto the main rod 1. The main body 2 is rotatable with respect to the main rod 1 around the axial direction. In addition, the main body 2 is movable with respect to the main rod 1 along the axial direction. On the other hand, the main body 2 further has a second through hole 24 penetrating both the two arms 22, 23. Specifically, extending directions of the first through hole 21 and the second through hole 24 are not parallel to each other. Preferably, the extending directions of the first through hole 21 and the second through hole 24 are substantially perpendicular to each other. Besides, the two arms 22, 23 are separated from each other by a predetermined distance and define a breach 25 therebetween. The breach 25 crosses the second through hole 24 and communicates with the first through hole 21.

The positioning member 3 and the fastening member 4 are rotatably disposed at two sides of the second through hole 24 respectively. The positioning member 3 has an aperture 31 for a support 7 of a musical instrument to insert through. Preferably, the aperture 31 has an internal diameter slightly larger than an external diameter of the support 7 of the musical instrument to allow the support 7 is able to move or rotate in the aperture 31. The positioning member 3 is alternatively engaged with the fastening member 4. More specifically, the fastening member 4 is formed with a threaded hole 41, and the positioning member 3 has an external threads portion 32 at an end away from the aperture 31. The external threads portion 32 of the positioning member 3 is inserted through the second through hole 24 and the threaded hole 41 to be screwed with the fastening member 4 so that the positioning member 3 and the fastening member 4 approach each other. Thereby, when the positioning member 3 and the fastening member 4 are fastened together, a distance between the two arms 22, 23 is reduced. In other words, a width of the breach 25 is reduced so that the main body 2 and the main rod 1 are fastened together to prevent from moving. Because the positioning member 3 is rotatably disposed in the second through hole 24, angle between the support 7 and the main body 2 are able to be adjusted by rotating the positioning member 3. Besides, when the positioning member 3 and the fastening member 4 are fastened together, the support 7 abuts against an outer surface of the main body 2 and is positioned in the aperture 31 of the positioning member 3, as shown in FIG. 3.

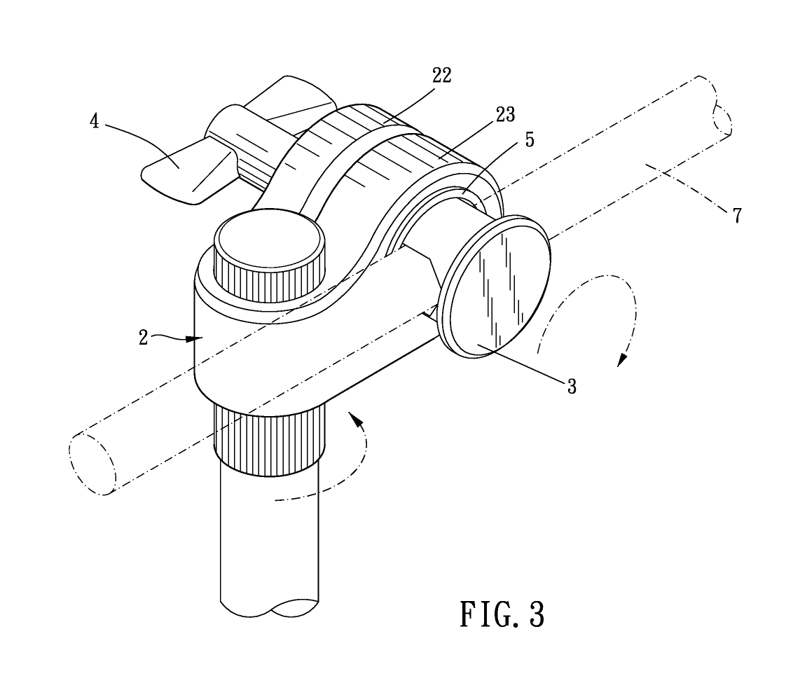

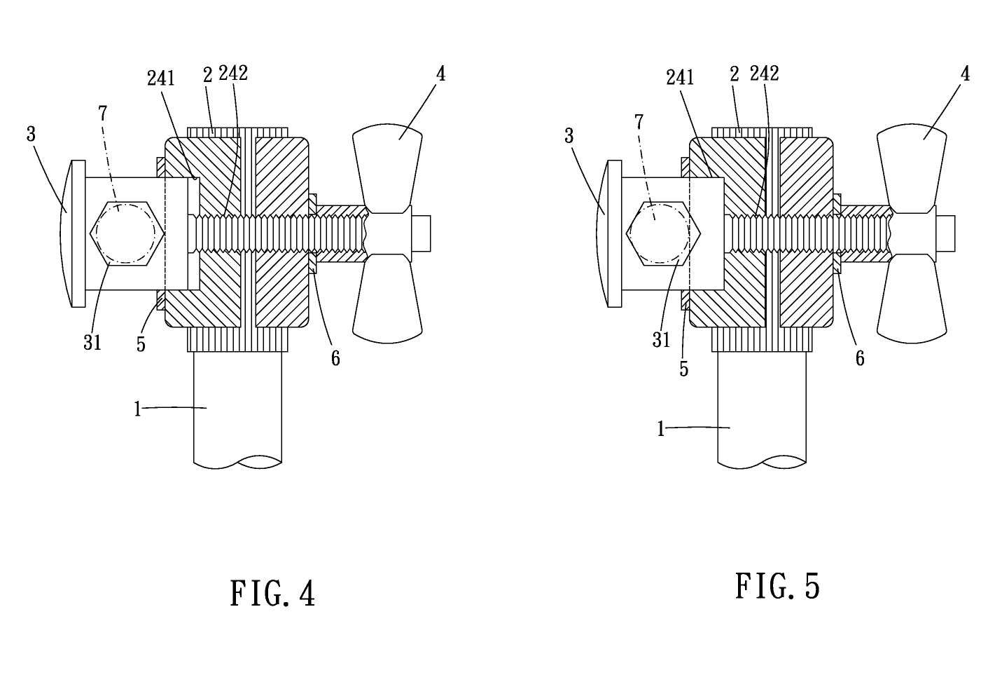

Preferably, please refer to FIGS. 1, 4, and 5, the universal connector of the present invention further includes at least one first annular pad 5 and at least one second annular pad 6. Specifically, the second through hole 24 includes a widened section 241 and a narrowed section 242. The widened section 241 is located at an end of the second through hole 24 away from the breach 25, and the narrowed section 242 is adjacent to the widened section 241. The first annular pad 5 is disposed on the outer surface of the main body 2. When the positioning member 3 and the fastening member 4 are fastened together the positioning member 3 is partially located in the widened section 241. Meanwhile, the first annular pad 5 is sandwiched between the main body 2 and the support 7, and the second annular pad 6 is sandwiched between the fastening member 4 and the main body 2. Thereby, the first annular pad 5 and the second annular pad 6 play roles in cushions among the main body 2, the positioning member 3, and the fastening member 4.

In practice, please refer to FIGS. 1 to 5, the main body 2 can be moved along the axial direction and be rotated around the axial direction to reach a desired position and direction. Meanwhile, the positioning member 3 can be rotated with respect to the main body 2 to adjust the angle between the support 7 and the main body 2. Thereafter, the positioning member 3 and the fastening member 4 are moved toward each other by screwing so as to fasten the main body 2 and the rod 1 together. The knurling 11 on the main rod 1 helps increase friction between the main body 2 and the main rod 1 to prevent them from moving with respect to each other. On the other hand, when the positioning member 3 and the fastening member 4 are fastened together, the support 7 abuts against the main body 2 and is positioned in the aperture 31.

To adjust position or angle of the main body 2 or the support 7, the positioning member 3 and the fastening member 4 are able to be loosened so that the main body 2 is able to rotate or move along the axial direction for adjusting height or direction of the support, and that the support 7 is able to rotate or move in the aperture 31 with respect to the positioning member 3 for adjusting the direction or position thereof. After adjustment, the positioning member 3 and the fastening member 4 are fastened together again for positioning.

What is claimed is:

1. A universal connector, including:
a main rod, defining an axial direction;
a main body, having a first through hole and two arms, the main body being sleeved onto the main rod by the first through hole, the main body being rotatable with respect to the main rod around the axial direction, the main body being also movable with respect to the main rod along the axial direction, the main body further having a second through hole which penetrates through both the two arms, extending directions of the first through hole and the second through hole being not parallel to each other, a breach being defined between the two arms, the breach crossing the second through hole and communicating with the first through hole;
a positioning member and a fastening member, the positioning member and the fastening member being rotatably disposed at two sides of the second through hole of the main body respectively, the positioning member having an aperture for a support of a musical instrument to insert through, the positioning member and the fastening member being engaged with each other alternatively;
wherein when the positioning member and the fastening member are engaged with each other, a gap between the two arms is reduced to fasten the main body and the main rod together, and the support of the musical instrument abuts against an outer surface of the main body and is positioned in the aperture of the positioning member.

2. The universal connector of claim 1, further including at least one first annular pad, the second through hole having a widened section and a narrowed section, the widened section being located at an end of the second through hole away from the breach, the narrowed section being adjacent to the widened section, the at least one first annular pad being disposed on the outer surface of the main body, when the positioning member and the fastening member are fastened together, the positioning member being partially received in the widened section and the at least one first annular pad being sandwiched between the support of the musical instrument and the main body.

3. The universal connector of claim 2, further including at least one second annular pad, the at least one second annular pad being disposed between the fastening member and the main body, the at least one second annular pad being sandwiched between the fastening member and the main body when the positioning member and the fastening member are engaged with each other.

4. The universal connector of claim 1, wherein the fastening member is formed with a threaded hole, the positioning member is formed with an external threads portion at an end away from the aperture, the fastening member and the positioning member are able to screw with each other and to further approach each other so that the support of the musical instrument abuts against the outer surface of the main body tightly.

5. The universal connector of claim 1, wherein an outer surface of the main rod is partially formed with knurling to increase friction between the main body and the main rod.
